(19) United States
(12) Patent Application Publication
(10) Pub. No.: US 2020/0394757 A1
(43) Pub. Date: Dec. 17, 2020

(54) METHOD FOR MARKING AN IMAGE REGION IN AN IMAGE OF AN IMAGE SEQUENCE

(71) Applicant: Scholly Fiberoptic GmbH, Denzlingen (DE)

(72) Inventors: Martin BOHNING, Herzogsweiler (DE); Frank HASSENPFLUG, Villingen-Schwenningen (DE); Andreas HILLE, Villingen-Schwenningen (DE); Michael KRONENTHALER, Villingen-Schwenningen (DE)

(73) Assignee: Scholly Fiberoptic GmbH, Denzlingen (DE)

(21) Appl. No.: 16/903,578

(22) Filed: Jun. 17, 2020

(30) Foreign Application Priority Data
Jun. 17, 2019 (DE) 102019116383.8

(51) Int. Cl. G06T 3/60; G06T 7/62; G06T 7/11

(52) U.S. Cl. CPC G06T 3/606; G06T 7/62; G06T 2207/30208; G06T 2207/10064; G06T 7/11

(57) ABSTRACT

A method for marking an image region in an image of an image sequence includes the steps of:
identifying (S2) an image region (3) in a first image (1) of the image sequence,
determining (S5) a transformation between the first image (1) and a second image (4) of the image sequence,
transforming (S6) the image region (3) on the basis of the determined transformation, and
presenting (S6) the transformed image region (3′) in the second image (4).

### INCORPORATION BY REFERENCE

The following documents are incorporated herein by reference as if fully set forth: German Patent Application No. DE 10 2019 116 383.8, filed Jun. 17, 2019.

### TECHNICAL FIELD

The invention relates to a method for marking an image region in an image of an image sequence.

### BACKGROUND

In surgical interventions, a piece of tissue, for example a tumor, is often made visible by means of a fluorescent dye and appropriate illumination. By way of example, the relevant piece of tissue can be made more visible in this way.

A problem here is that the fluorescence of the tissue region, i.e., the colored marking, disappears over time. Moreover, a further problem is that it is difficult to keep the image section constant, especially in endoscopy, and so it is difficult to continue to track the identified region without dye in the image sequence.

Then, as a rule, new dye has to be applied so that the region remains visible. However, this may be undesirable for various reasons.

### SUMMARY

Therefore, it is an object of the invention to develop an improved method for marking an image region in images of an image sequence.

This object is achieved by the method having one or more features of the invention.

Accordingly, the method according to the invention includes the steps of:
identifying an image region in a first image of the image sequence, in particular by segmentation,
determining a transformation between the first image and a second image of the image sequence,
transforming the image region on the basis of the determined transformation, and
presenting the image region in the second image.

Accordingly, the selected image region is transferred from the first image to each further image in an image sequence, for instance in a video stream, and presented therein.

This allows an image region, once labeled, to be tracked in a running video signal.

The method is particularly advantageous in the field of medicine, as it allows a tissue region, once labeled in color, to still be tracked even if the colored marking, e.g., the fluorescence, has decayed. In this case, the frequency of administering, e.g., fluorochromes or other dyes can be reduced.

However, the method can also be advantageously used in other fields of application. By way of example, the region can be identified with the aid of a thermal imaging camera on the basis of a temperature range and it can be permanently marked in the running video signal.

However, the region to be processed can also be marked manually, for example.

Accordingly, the method according to the invention is applicable to any type of image sequence, in particular video signals but also a sequence of individual images.

Accordingly, in one embodiment, the steps of determining, transforming, and presenting are carried out repeatedly for further images of the image sequence. In particular, the image processing can be implemented so quickly that it is performable on a video signal in real time and each image is processed.

However, it may also be sufficient for only every second or every n-th image of a video signal to be processed.

In principle, the image region is presented in the second image as identified in the first image. However, it is also possible for the image region to be altered for presentation purposes, in particular in terms of color, transparency, contrast or brightness.

In one embodiment, presenting the image region only comprises a perimeter of the image region being presented. In this way, only a boundary of the image region is presented and the view of the actual image within the image region is not covered or falsified. This facilitates improved visual monitoring of a surgical intervention, for example within the scope of endoscopy.

In one embodiment, the image region is presented by a superposition of the fitted image region in the second image.

In one embodiment, the superposition in the second image is implemented by alpha blending. Here, the intensity of the superposition, in particular, can be changeable such that the live image may still be visible.

In one embodiment, a transformation is determined on the basis of correspondences between image content between the first image and a second image.

Here, it may be advantageous, in particular, if the image content used to determine the transformation is located outside of the identified region.

In one embodiment, a geometric transformation with a plurality of degrees of freedom is used to determine a transformation. By way of example, this allows rotations, shearings, scalings, and translations to be described.

Expediently, eight degrees of freedom are used to this end.

Furthermore, use can be made, in particular, of a matrix transformation.

In one embodiment, the identification in the first image is implemented on the basis of a colored or any other marker in the image region.

In one embodiment, the region is marked in color by fluorescence, for example by the addition of fluorochromes.

In principle, the image region can be identified manually in the first image, for example on a monitor.

In one embodiment, the identification is implemented in automated fashion. Here, use can be made of a colored marker, in particular. By way of example, a fluorescing dye can be illuminated by a UV light source. By way of example, the image arising thus can be directly identified and used as an image region.

In one embodiment, the identification includes buffering of the image region.

It is particularly advantageous if a video processing unit, in particular an FPGA, is used to carry out the method.

### BRIEF DESCRIPTION OF THE DRAWINGS

The invention is explained in more detail below on the basis of an exemplary embodiment with reference to the appended drawings.

In the figures:

FIG. 1: shows a flowchart of a method according to the invention,

FIG. 2: shows a first image with an image region marked in color,

FIG. 3: shows the identified image region,

FIG. 4: shows a second image in the image sequence, in which the colored marker is no longer visible,

FIG. 5: shows the image region transformed in accordance with the second image, and

FIG. 6: shows the second image with the superposed transformed image region.

### DETAILED DESCRIPTION

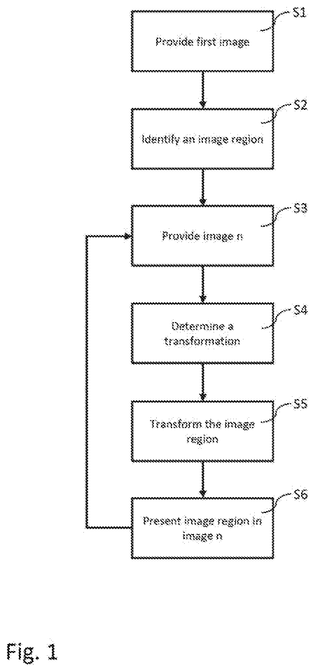

FIG. 1 shows a flowchart of a method according to the invention. By way of example, the method is carried out in an image processing unit or a video processing unit, in particular with an FPGA.

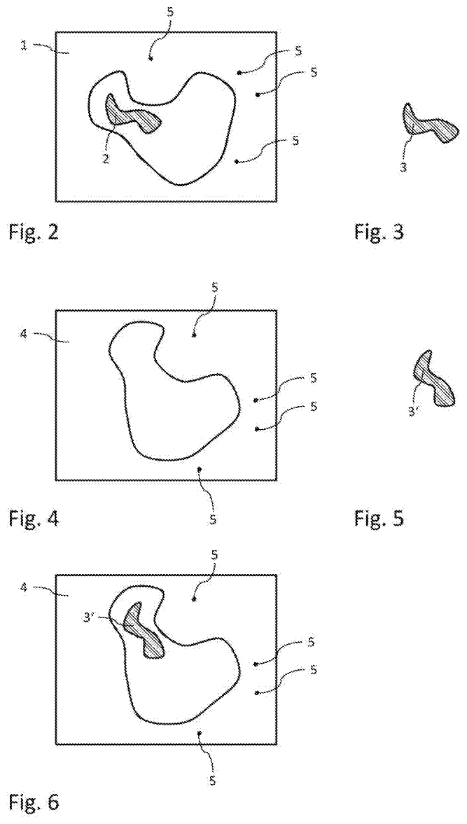

A first image 1 of an image sequence is provided in a first step S1. Such a first image 1 is shown in exemplary fashion in FIG. 2.

In this case, FIG. 2 shows, in exemplary fashion, an endoscopic image 1 in which a piece of tissue 2, for instance a tumor, has been marked in color using a fluorescent dye.

An image region 3 which should be tracked in subsequent images, i.e., marked, is now identified in the first image 1 in an identification step S2. In the example, the identification can be implemented on the colored marking, for example by segmentation. By way of example, this can be implemented in automated fashion by virtue of only the fluorescent image region being recorded under UV light.

The identified image region 3 (see FIG. 3) is buffered separately from the first image 1.

A second n-th image of the image sequence is loaded in an image loading step S3. Such a second image 4 is shown in exemplary fashion in FIG. 4. The second image 4 shows the same image scene as FIG. 2. However, the second image is rotated and possibly displaced on account of a camera movement. Moreover, the colored marker is missing, for example because the fluorescence has already decayed.

Now, a geometric transformation that maps the first image 1 onto the second image 4 is determined in a determination step S4. Here, correspondences 5 between image content are searched in the images, the image content preferably being located outside of the identified image region.

By way of example, the correspondences 5 could be image features which can be easily and reliably identified by an algorithm. By way of example, to this end, known object tracking algorithms or algorithms for feature detection, for instance for edge detection, can be applied. With the aid of a matrix transformation, for example with eight degrees of freedom, the transformation can be determined on the basis of the relative position of the corresponding image content.

Now, the image region 3 is transformed in a transformation step S5 using the previously determined transformation. The result is shown in exemplary fashion in FIG. 5. The transformed image region 3′ is rotated in relation to the original image region 3 in FIG. 3.

Finally, the transformed image region 3′ is presented in superposed fashion in the second image 4 in a presentation step S6. By way of example, an alpha blending method can be applied to this end.

The result of the presentation S6 is shown in exemplary fashion in FIG. 6. Now, the marked image region 3′ is visible in the second image 4 as if the fluorescent dye was still visible.

Therefore, the method according to the invention renders it possible to continue to make an image region, once identified, visible in a running video signal or in an image sequence even though the image is constantly changing, for example on account of camera movements. Here, even discontinuous changes do not lead to problems for as long as it is possible to determine a geometric transformation between images.

Then, the method is continued with the provision of the next image in the image loading step S3.

In particular, it is advantageous here if the method always determines the transformation from the first image and not from possible preceding images.

### LIST OF REFERENCE SIGNS

1 First image
2 Piece of tissue marked by color
3 Identified image region
3′ Transformed, marked image region
4 Second image
5 Correspondence
S1-S6 Method steps

1. A method for marking an image region in an image of an image sequence, comprising the steps of:
identifying (S2) an image region (3) in a first image (1) of the image sequence,
determining (S4) a transformation between the first image (1) and a second image (4) of the image sequence,
transforming (S5) the image region (3) based on the determined transformation, and
presenting (S6) the transformed image region (3′) in the second image (4).

2. The method as claimed in claim 1, wherein the steps of determining (S4), transforming (S5), and presenting (S6) are repeated for further images in the image sequence.

3. The method as claimed in claim 1, wherein the presenting (S6) of the transformed image region (3′) only comprises a presentation of a perimeter of the image region (3).

4. The method as claimed in claim 1, wherein the transformed image region (3′) is presented utilizing a superposition of the image region (3) in the second image (4).

5. The method as claimed in claim 4, wherein the superposition in the second image (4) is implemented by alpha blending.

6. The method as claimed in claim 1, wherein the transformation is determined based on correspondences (5) between image content between the first image (1) and the second image (4) in particular wherein the image content is located outside of the identified region (3).

7. The method as claimed in claim 6, wherein the image content is located outside of the identified region (3)

8. The method as claimed in claim 1, wherein a geometric transformation with a plurality of degrees of freedom is used for determining the transformation.

9. The method as claimed in claim 8, wherein the geometric transformation is a matrix transformation with eight degrees of freedom.

10. The method as claimed in claim 1, wherein the identification in the first image (1) is implemented based on a colored marker or any other marker (2) in the image region (3).

11. The method as claimed in claim 1, wherein the image region (3) is marked (2) in color by fluorescence.

12. The method as claimed in claim 11, wherein the fluorescence is provided by addition of fluorochromes.

13. The method as claimed in claim 1, wherein the identification is implemented in automated form by recording an image using a different illumination source.

14. The method as claimed in claim 1, wherein the identification comprises buffering of the image region (3).

15. The method as claimed in claim 1, wherein the identifying (S2) of the image region (3) in the first image (1) of the image sequence is carried out by segmentation.
